(19) United States
(12) Patent Application Publication
(10) Pub. No.: US 2011/0030196 A1
(43) Pub. Date: Feb. 10, 2011

(54) Method for Making a Socket with a Clear Marking Unit

(76) Inventor: Shu-Yuan HSIEH, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/909,770

(22) Filed: Oct. 21, 2010

Related U.S. Application Data
(62) Division of application No. 12/253,183, filed on Oct. 16, 2008.

(51) Int. Cl. B23P 17/00

(52) U.S. Cl. 29/527.4

(57) ABSTRACT

Disclosed is a method for making a socket apparatus. In the method, there is provided a socket that includes an external side. An indented mark is made in the external side of the socket. A colored layer is provided on a portion of the external side of the socket including the indented mark. A colored mark is left in the indented mark by removing the portion of the colored layer outside the indented mark. A coating is provided on the external side of the socket except the colored mark. The coating does not stick to the colored mark.

### CROSS-REFERENCE TO RELATED REFERENCE

The present application is a divisional application of U.S. patent application Ser. No. 12/253183 filed on 16 Oct. 2008.

### FIELD OF INVENTION

The present invention relates to a socket wrench and, more particularly, to a method for making a socket with a clear marking unit.

### BACKGROUND OF INVENTION

To drive a threaded bolt or nut, an open-ended wrench, box-ended wrench, monkey wrench or socket wrench may be used. A socket wrench kit includes a handle and a set of sockets of various sizes. In operation, the handle is connected to a selected one of the sockets for driving a threaded bolt or nut of a certain size. Thus, a socket wrench kit can be used to drive threaded bolts or nuts of various sizes. A socket wrench kit is lighter and less expensive than a set of open-ended wrenches or box-ended wrenches. The handle of a socket wrench kit often includes a selective one-way driving mechanism. Therefore, a socket wrench kit is more convenient than a monkey wrench. It is important to mark the sockets of a socket wrench kit to indicate the sizes of the sockets. Traditionally, indented marks are made in the sockets by pressing. The indented marks are however unclear on the sockets. The pressing requires an expensive machine.

As disclosed in Taiwanese Patent Publication Nos. 555626, 566272 and M243306 and U.S. Pat. No. 6393950, embossed marks are made on the sockets by casting or indented marks are made in the sockets by pressing. However, the embossed or indented marks are unclear on the sockets for being in the same color as the sockets. Moreover, the embossed or indented marks are limited to simple patterns because of limitation of the casting and molds used in the casting.

As disclosed in Taiwanese Patent Publication Nos. 555626 and M250756, a socket is formed with a groove and an indented mark by pressing. The indented mark is covered with an electroplated layer. A colored mark is provided on the electroplated layer. The indented mark is clear on the socket. However, the colored mark could easily be peeled from the electroplated layer because the electroplated layer is smooth.

The present invention is therefore intended to obviate or at least alleviate the problems encountered in prior art.

### SUMMARY OF INVENTION

It is the primary objective of the present invention to provide a socket with a clear and durable marking unit.

To achieve the foregoing objective, there is provided a method for making a socket with a clear and durable marking unit. In the method, there is provided a socket that includes an external side. An indented mark is made in the external side of the socket. A colored layer is provided on a portion of the external side of the socket including the indented mark. A colored mark is left in the indented mark by removing the portion of the colored layer outside the indented mark. A coating is provided on the external side of the socket except the colored mark. The coating does not stick to the colored mark.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings wherein:

FIG. 1 is a perspective view of a socket with a mark made based on a method according to the preferred embodiment of the present invention;

FIG. 2 is a cross-sectional view of the socket in a first phase of fabrication to form the mark shown in FIG. 1;

FIG. 3 is a cross-sectional view of the socket shown in FIG. 2;

FIG. 4 is a cross-sectional view of the socket in a second phase of fabrication to form the mark shown in FIG. 1;

FIG. 5 is a cross-sectional view of the socket shown in FIG. 4;

FIG. 6 is a cross-sectional view of the socket in a third phase of fabrication to form the mark shown in FIG. 1; and

FIG. 7 is a cross-sectional view of the socket shown in FIG. 6.

### DETAILED DESCRIPTION OF PREFERRED EMBODIMENT

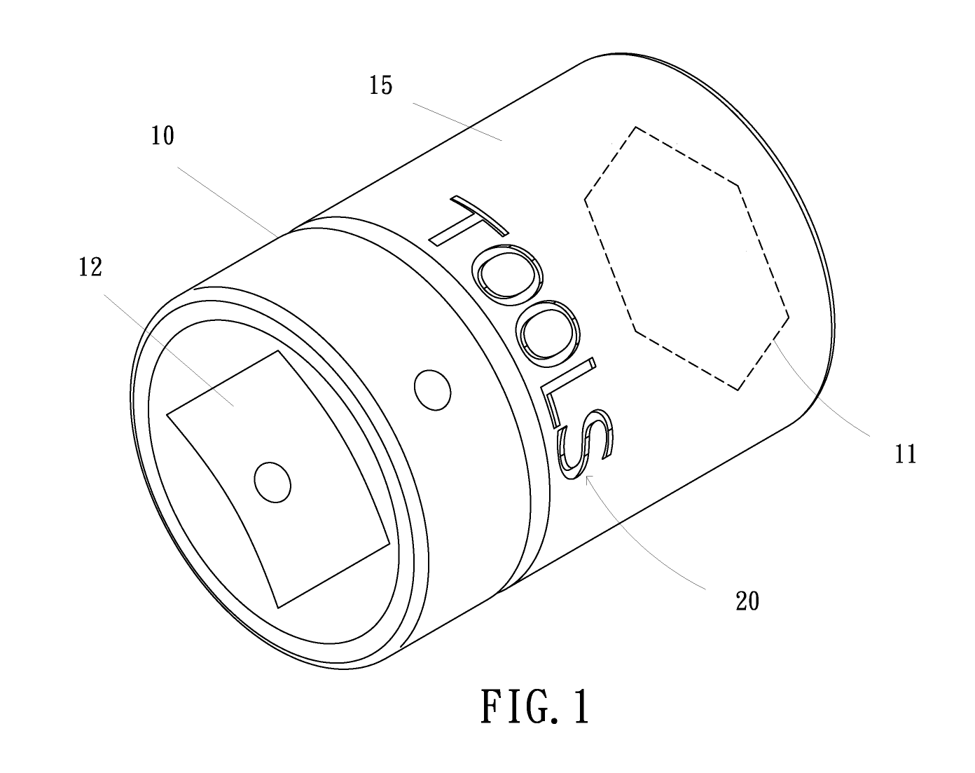

Referring to FIG. 1, there is shown a socket 10 with a marking unit 20 according to the preferred embodiment. The marking unit 20 is used to mark the size, trademark or manufacturer of the socket. The socket 10 and the marking unit 20 will be described in detail.

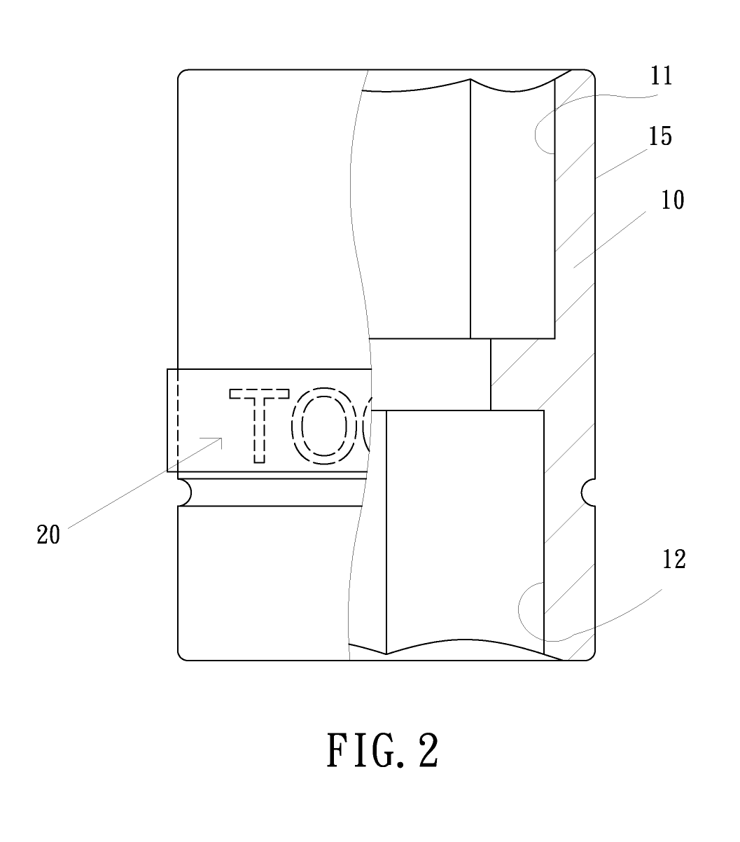

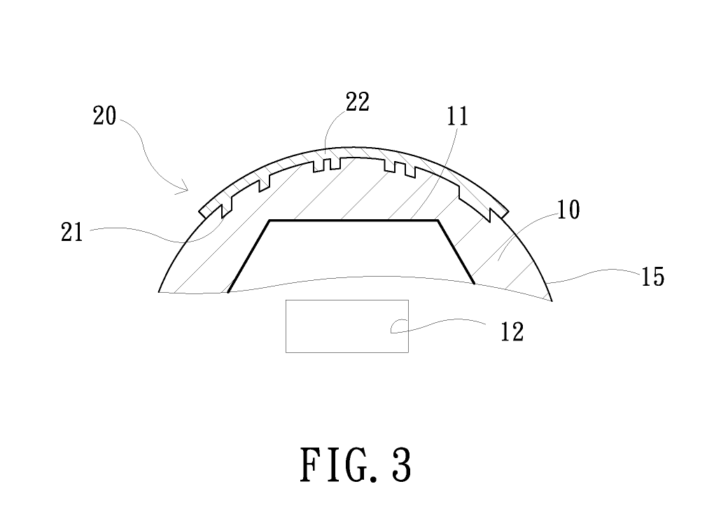

Referring to FIGS. 2 and 3, the socket 10 includes a first cavity 11 defined in a section and a second cavity 12 defined in another section. The first cavity 11 is used to receive a nut or the head of a threaded bolt. The second cavity 12 is used to receive a portion of a handle of a socket wrench kit. The socket 10 is formed with an external side 15.

An indented mark 21 is made in the external side 15 of the socket 10. A color layer 22 is provided on the external side 15 of the socket 10. The indented mark 21 and an adjacent region of the external side 15 of the socket 10 are covered with the color layer 22.

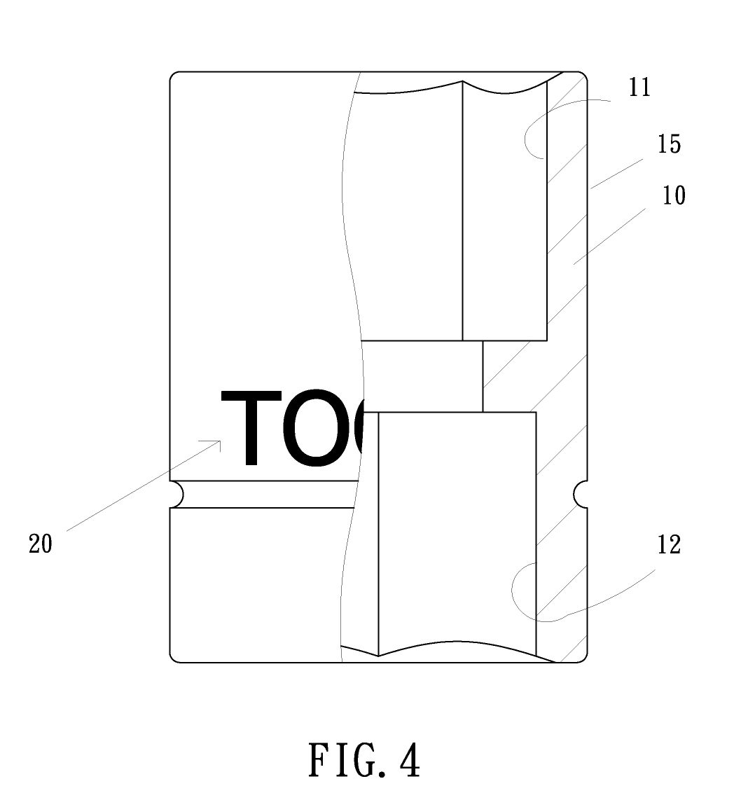

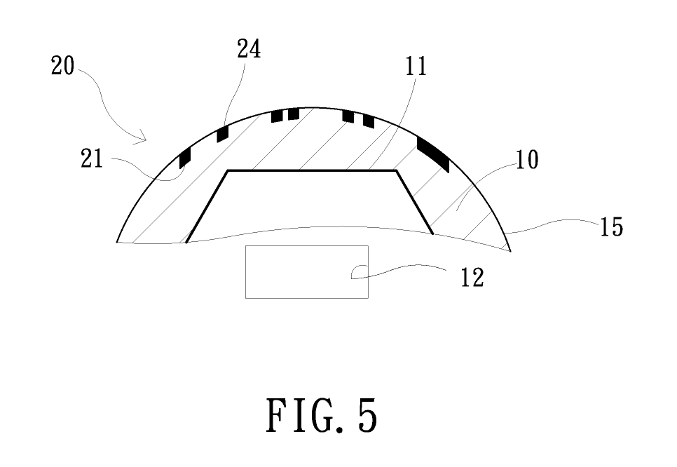

Referring to FIGS. 4 and 5, the portion of the color layer 22 beyond the indented mark 21 is removed by grinding. Thus, a colored mark 24 is left in the indented mark 21.

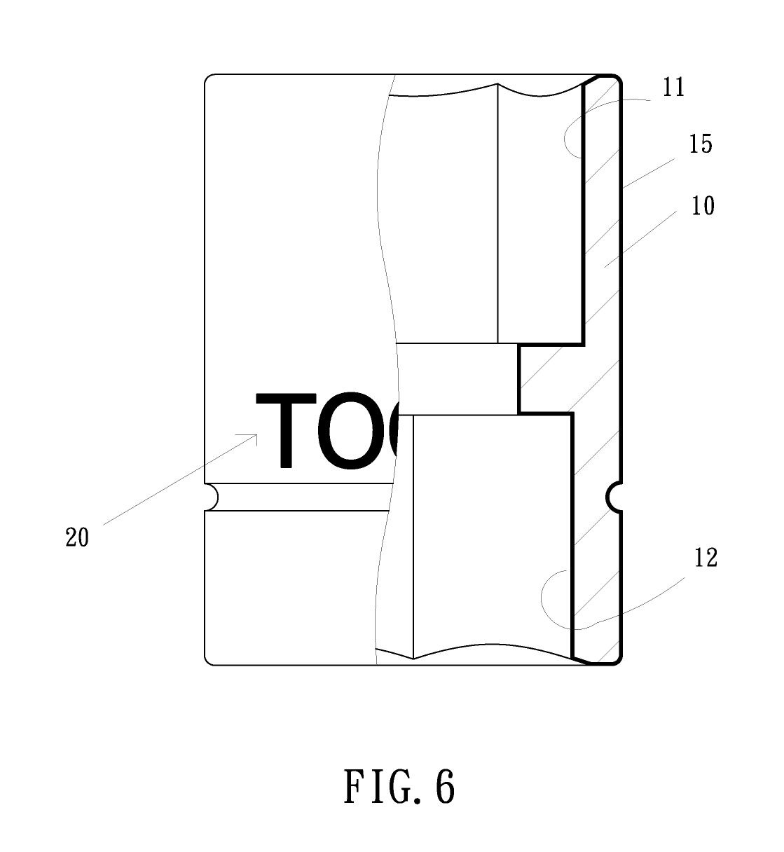

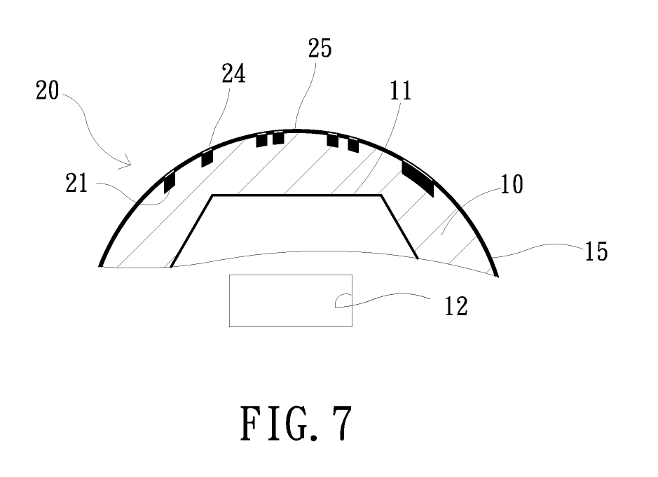

Referring to FIGS. 6 and 7, a coating 25 of manganese phosphate for example is provided on the colored mark 24 and the external side 15 of the socket 10. The coating 25 however does not stick to or cover the colored mark 24. The color of the coating 25 is dark and in strong contrast with the color of the colored mark 24 so that the colored mark 24 is eye-catching amid the coating 25.

The colored mark 24 is firmly attached to the indented mark 21 because the indented mark 21 is rough in comparison with an electroplated layer. In addition, the colored mark 24 is clear amid the coating 25 because the color of the coating 25 is in strong contrast with the color of the colored mark 24.

Advantageously, the colored layer 22 is only provided on the portion of the external side 15 of the socket 10 including the indented mark 21 before the portion of the colored layer 22 outside the indented mark 21 is removed. Thus, only a little material of the colored layer 22 is wasted, and only a little time and energy are spent on removing the portion of the colored layer 22. Therefore, the cost is low.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for making a socket apparatus with a marking unit, the method including the steps of:
providing a socket with an external side;
making an indented mark in the external side of the socket;
providing a colored layer on a portion of the external side of the socket including the indented mark;
leaving a colored mark in the indented mark by removing the portion of the colored layer outside the indented mark; and
providing a coating on the external side of the socket except the colored mark, wherein the coating does not stick to the colored mark.

2. The method according to claim 1, wherein the step of providing a coating on the external side of the socket except the colored mark includes the step of providing a coating of manganese phosphate on the external side of the socket except the colored mark.
